(19) United States
(12) Patent Application Publication
(10) Pub. No.: US 2010/0052260 A1
(43) Pub. Date: Mar. 4, 2010

(54) DEVICE AND METHOD FOR PRODUCING A SEAL

(75) Inventors: Josef Burger, Schmidgaden (DE); Richard Schmidt, Baiersdorf (DE)

Correspondence Address: HARNESS, DICKEY & PIERCE, P.L.C., P.O.BOX 8910, RESTON, VA, 20195, US

(73) Assignee: SIEMENS AKTIENGESELLSCAHFT, Muenchen (DE)

(21) Appl. No.: 12/449,971

(22) PCT Filed: Mar. 7, 2007
(86) PCT No.: PCT/EP2007/001974

§ 371 Date: Sep. 4, 2009

(51) Int. Cl. F16J 15/02

(52) U.S. Cl. 277/316; 277/630

(57) ABSTRACT

A device is disclosed for producing a seal between a first part and a second part, especially a first housing part and a second housing part. The seal can be produced according to a physical property of an electroactive plastic material which can be modified. A device for receiving an electrical circuit and/or a device including electrical switching device is also disclosed, having at least one first and one second housing part operating as a first part and a second part, with an above-mentioned device. A method is further disclosed for producing a seal between a first part and a second part, especially a first housing part and a second housing part, by way of such a device, a first electrical voltage being applied to create the seal, and a second electrical voltage being applied to lift the seal.

### PRIORITY STATEMENT

This application is the national phase under 35 U.S.C. §371 of PCT International Application No. PCT/EP2007/001974 which has an International filing date of Mar. 7, 2007, which designated the United States of America, the entire contents of which are hereby incorporated herein by reference.

### FIELD

At least one embodiment of the invention generally relates to a device for producing a seal between a first part and a second part, for example a first housing part and a second housing part. It also generally relates to a device for accommodating an electrical circuit and/or a device including at least one electrical switching device and/or a method for producing such a seal.

### BACKGROUND

Housing parts, e.g. of electronic devices, frequently comprise a number of parts, which are connected to one another in a detachable or non-detachable manner and sealed, which is generally achieved by bolting, riveting, latching or adhesion, in particular incorporating a flexible sealing element, e.g. a sealing ring. In the case of housing parts of electronic devices in particular these parts are frequently made of plastic materials and during their production tolerances, e.g. in dimensions, and/or shape deviations result, for example due to a production process, and these have to be reduced or avoided at least for higher quality products by tailoring the parts to one another in a cost-intensive and time-intensive manner. Also additional elements, e.g. the sealing elements, must also be tailored to the parts, kept in stock or if necessary made specifically to fit. Furthermore, if seals for example are not connected permanently to at least one part, they can get lost and/or when used a number of times such elements can be subject to wear, which in some instances renders them unusable.

A device for producing a sealed connection for two or more parts of a heat exchanger is known for example from EP 0 302 618, comprising an annular or tubular connecting component from a shape-memory effect (SME) material based on copper, zinc, aluminum and titanium/nickel (NiTi) alloys, which is also able to undergo thermoelastic deformation. A compressible component, shaped in the manner of a split ring with a closable gap, is positioned between the connecting component and two parts to be connected, between which there is in turn a sealing ring. The thermoelastic reshaping of the connecting component compresses the compressible component and closes the gap, thereby connecting the two parts in a sealed manner.

However this has a disadvantage of the material-intensive, cost-intensive and time-intensive, complex production of the seal or parts thereof and a complicated time-intensive and cost-intensive construction of the device for connecting and sealing the parts.

### SUMMARY

At least one embodiment of the invention is directed to reducing or even minimizing at least one of these disadvantages or impacts of such disadvantage(s).

In at least one embodiment, provision is made for the seal to be produced as a function of a physical characteristic of a plastic material and for it to be possible to modify the physical characteristic of the plastic material as a function of an electrical voltage.

The plastic material provided here is a plastic material referred to in the following as an electroactive plastic material, wherein at least one of its physical characteristics can be modified as a function of an energy in the form of an electrical voltage. Additionally or alternatively the energy can be a current flow correlated with the electrical voltage, an electromagnetic field, a heat energy or a light energy.

The term seal is used here and in the following to refer to a form fit of at least two components, parts or the like, by which it is possible to reduce or minimize an exchange of fluids, gases or particles between at least a first compartment adjacent to a first side of the seal and a second compartment adjacent to a second side of the seal. The seal can be produced once or a number of times and/or be provided and embodied as short-term or permanent. If the term seal relates to a material seal, the seal can be an interchangeable element for example or a component of at least one of the parts itself.

Further advantages and details will emerge. References used there refer to a further embodiment of the subject matter; they should not be understood as a renunciation of the attainment of independent material protection for the feature combinations of the subclaims referred to. It should also be assumed in respect of an interpretation of the claims with a more specific concretization of a feature in a subordinate claim that there is no such restriction in the respectively preceding claims.

The physical characteristic of the electroactive plastic material is preferably a shape or volume of the electroactive plastic material. It is possible to produce the seal in a simple and economical manner by modifying the shape, volume or shape and volume, since complex tailoring of parts to be sealed and/or parts and seal is no longer necessary or can be simplified.

The device of at least one embodiment preferably comprises at least one sealing element formed at least partially of electroactive plastic material. Additionally or alternatively at least the first and/or second part can also be molded at least partially from electroactive plastic material and a seal can be produced using this. This allows the seal to be tailored simply and more readily for example to spatial conditions, intended use or different housings and therefore more economical realization of the seal.

It is also preferably possible for the electroactive plastic material to change at least from a first shape to a second shape and from the second shape to the first shape by way of the electrical voltage. When the first shape is present the sealing element brings about a seal between the first part and the second part. Also when the second shape is present the sealing element can be provided as non-sealing. The first shape can be assumed when the electrical voltage is applied, with energy being supplied to the plastic material to produce the seal in this instance. Alternatively, when energy is supplied, the plastic material can assume the second shape in which no seal is produced and the first shape can be present without a supply of energy. This minimizes energy consumption with an existing seal, resulting in a reduction of costs.

The sealing element is preferably associated in a captive manner with the first or second part. Alternatively the sealing element can be embodied as a “loose” or interchangeable sealing element, which can be associated at least temporarily with at least one of the parts. This allows the sealing element to be exchanged and renewed more easily and costs to be reduced, since just a sealing element affected by wear for example can be exchanged as required.

It is particularly preferable for the sealing element to be a sealing lip associated with the first part and the second part to comprise a recess corresponding to the sealing lip. In the event of engagement in the recess the sealing lip is also active in latching the first part to the second part. This allows a simple and economical twin function to be realized, in other words sealing and connecting.

The electroactive plastic material is preferably a plastic material with a shape memory effect, which can assume at least a first shape (e.g. initial shape) with a first volume (e.g. initial volume), a second, third, fourth, etc. shape with a second, third, fourth, etc. volume. It is also possible for the plastic material to change its shape but not its volume or its volume but not its shape. Changes are thus possible for example from the first shape with the first volume to the third shape still with the first volume. A change in shape or volume here can take place once or a number of times, for example as a function of the electrical voltage applied. Use of the electroactive plastic material with shape memory thus allows the seal to be realized with a simple construction and in an economical manner. Additionally or alternatively the plastic material can assume at least the initial shape or initial volume gradually or continuously, thereby allowing flexible deployment and the possibility of tailoring to different requirements, e.g. housing shapes or deployment sites of the housing.

With regard to the device for accommodating an electrical circuit and/or a device comprising electrical switching device, according to at least one embodiment of the invention, the device includes at least a first and second housing part functioning as the first and second part with such a device or the device described below. The device here can be a housing for example comprising electrical components, a switchgear cabinet or the like. The seal here can relate for example to at least a door, a cable passage or a fastening device and can seal these at least partially against the unwanted penetration and/or egress of moisture, fluids, gases and/or particles for example.

With such a device for producing a seal it is possible for the electrical voltage to be applied by way of a voltage source which is part of said device or can be associated at least temporarily with it. In one example the device comprises a lock, with a power circuit that can be established by inserting a key. A voltage source can be provided for the power circuit either on the side of the key or on the side of the lock; in both instances electrical energy is applied to the device to produce a seal by inserting the key and thereby closing the power circuit, so the seal is established or released.

In addition a particularly suitable method for produced a seal between a first part and a second part, in particular a first housing part and a second housing part, by way of such a device or the device described below is to be specified. With this a first electrical voltage is applied to produce the seal and a second electrical voltage is applied to release the seal. The first or second electrical voltage applied here can be “zero”; it is thus possible to apply just one electrical voltage either to produce or release the seal.

### BRIEF DESCRIPTION OF THE DRAWINGS

An example embodiment of the invention is described in more detail below with reference to the drawing but thus should not be considered to restrict the invention. Instead numerous changes and modifications are possible within the context of the present disclosure, in particular those variants and combinations which emerge for the person skilled in the art with regard to achieving an object for example by combining or modifying individual features and/or elements or method steps in conjunction with those described in the general or specific portion of the description and contained in the claims and/or drawing and by features that can be combined to produce a new subject matter or new method steps or method step consequences. Corresponding objects or elements are shown with the same reference characters in all the figures.

In the single FIGURE

FIG. 1 shows a schematic diagram of a vertical section through a device for producing a seal.

### DETAILED DESCRIPTION OF THE EXAMPLE EMBODIMENTS

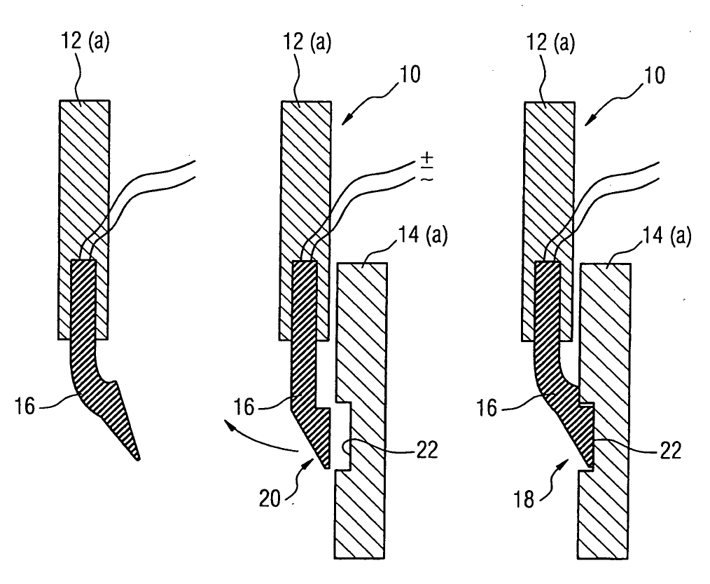

FIG. 1 shows a schematic diagram of a vertical section through a device 10 for producing a seal between a first part 12 and a second part 14, in particular a first housing part 12a and a second housing part 14a. A sealing element 16 made of electroactive plastic material is associated in a captive manner with the first part 12. When no electrical voltage is applied, the sealing element 16 has a first shape 18; when an electrical voltage is applied, the sealing element 16 changes to a second shape 20. In this first shape 18 the sealing element 16 corresponds to a recess 22 in the second part 14, thereby producing a seal between the first part 12 and the second part 14, while with the second shape 20 the seal is released. Additionally or alternatively when the sealing element 16 engages in the recess 22, the first part 12 can also be latched to the second part 14.

An embodiment of the invention can thus be summarized briefly as follows: An embodiment of the invention relates to a device 10 for producing a seal between a first part 12 and a second part 14, in particular a first housing part 12a and a second housing part 14a, it being possible for the seal to be produced as a function of a physical characteristic of an electroactive plastic material and the physical characteristic of the electroactive plastic material being modifiable as a function of an electrical voltage, a device for accommodating an electrical circuit and/or a device comprising electrical switching device, with at least a first and second housing part 12a, 14a functioning as the first and second part 12, 14 with a device 10 of the type mentioned above and a method for producing a seal between a first part 12 and a second part 14, in particular a first housing part 12a and a second housing part 14a, by way of such a device 10, with a first electrical voltage being applied to produce the seal and a second electrical voltage being applied to release the seal.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A device for producing a seal between a first housing part and a second housing part of an electrical device, comprising:
an electroactive plastic material,
the seal being producible as a function of a physical characteristic of the electroactive plastic material and the physical characteristic of the electroactive plastic material being directly modifiable as a function of an electrical voltage.

2. The device as claimed in claim 1, wherein the physical characteristic of the electroactive plastic material is a shape or volume of the electroactive plastic material.

3. The device as claimed in claim 2, wherein at least one sealing element is formed at least partially of electroactive plastic material.

4. The device as claimed in claim 3, wherein the electroactive plastic material is changeable at least from a first shape to a second shape and from the second shape to the first shape by way of the electrical voltage, and wherein when the first shape is present, the sealing element brings about a seal between the first part and the second part.

5. The device as claimed in claim 4, wherein the sealing element is associated in a captive manner with the first or second part.

6. The device as claimed in claim 5, wherein the sealing element is a sealing lip associated with the first part and wherein the second part comprises a recess corresponding to the sealing lip.

7. The device as claimed in claim 1, wherein the electroactive plastic material is a plastic material with a shape memory effect.

8. The device as claimed in claim 1, further comprising a lock, wherein a power circuit is established by inserting a key into the lock, by way of which power circuit electrical energy is applied to the device to produce or release the seal.

9. An electrical device comprising:
at least a first and second housing part functioning as the first and second part with the device as claimed in claim 1.

10. A method for producing a seal between a first housing part and a second housing part of an electrical device, comprising:
applying a first electrical voltage to an electroactive plastic material produce the seal between the first housing part and the second housing part of the electrical device, a second electrical voltage being applyable to release the seal.

11. A device for producing a seal between a first housing part and a second housing part of an electrical device, wherein the seal is producible as a function of a physical characteristic of an electroactive plastic material, and wherein the physical characteristic of the electroactive plastic material is directly modifiable as a function of an electrical voltage.

12. An electroactive plastic material for producing a seal between a first housing part and a second housing part of an electrical device, the seal being producible as a function of a physical characteristic of the electroactive plastic material, and the physical characteristic of the electroactive plastic material being directly modifiable as a function of an electrical voltage.

13. The electroactive plastic material as claimed in claim 12, wherein the physical characteristic of the electroactive plastic material is a shape or volume of the electroactive plastic material.

14. The electroactive plastic material as claimed in claim 12, wherein the electroactive plastic material is changeable at least from a first shape to a second shape and from the second shape to the first shape by way of the electrical voltage, and wherein when the first shape is present, at least one sealing element being formed at least partially of electroactive plastic material to bring about a seal between the first part and the second part.

15. The electroactive plastic material as claimed in claim 14, wherein the sealing element is associated in a captive manner with the first or second part.

16. The electroactive plastic material as claimed in claim 15, wherein the sealing element is a sealing lip associated with the first part and wherein the second part comprises a recess corresponding to the sealing lip.

17. The electroactive plastic material as claimed in claim 12, wherein the electroactive plastic material is a plastic material with a shape memory effect.
